(19) United States
(12) Patent Application Publication
(10) Pub. No.: US 2004/0066710 A1
(43) Pub. Date: Apr. 8, 2004

(54) Voice-commanded alarm clock system, and associated methods

(76) Inventors: Wai Man Yuen, Hong Kong (CN); Kai Wai Wu, Hong Kong (CN)

Correspondence Address: LATHROP & GAGE LC, 4845 PEARL EAST CIRCLE, SUITE 300, BOULDER, CO, 80301, US

(21) Appl. No.: 10/670,686

(22) Filed: Sep. 25, 2003

Related U.S. Application Data
(60) Provisional application No. 60/415,926, filed on Oct. 3, 2002.

(51) Int. Cl. G04C 21/00; G04B 23/02

(52) U.S. Cl. 368/73

(57) ABSTRACT

Alarm clock systems, methods and AC power sockets employ voice synthesis technology to control functions without physical manipulation. One or more processors control clocking and alarm functions within a modular unit. A speech recognition processor digitizes and processes audible commands. A microphone senses the audible commands. The alarm clock may be programmed by the user to recognize and associate user-chosen audible commands with specific alarm functions, for example, the alarm clock system may be programmed to activate the alarm function in response to the command “Turn alarm on”. Audible prompts generated by a voice synthesizer and icons shown on a display of the alarm clock system assist the user in programming and setting. Voice command data is stored in an internal memory of the alarm clock system. A wireless transmitter and corresponding, removably attachable wireless receiver may be further integrated into the alarm or clocking functions of the alarm clock system to control other electronic devices, for example, a radio, television and/or a coffee machine.

### RELATED APPLICATIONS

This application claims priority to U.S. provisional application serial No. 60/415,926, filed Oct. 3, 2002 and hereby incorporated by reference.

### BACKGROUND

Alarm clocks are known in the prior art, and include digital and analog devices. The clocks of the prior art utilize buttons or knobs to set the timing and alarm functions. A user must therefore look at the alarm clock, or memorize an exact location or configuration, to manipulate the buttons or knobs and set the alarm. When the prior art alarm clock is mounted on a wall or at a high location, the user may need to climb onto a ladder or other support structure to access the clock, creating a dangerous situation due to risk of fall. When the prior art alarm clock is a desktop alarm clock, the user must find its location and then press a button to (a) stop the alarm and/or (b) activate a snooze feature. When the prior art alarm clock is a digital electronic device, the user must execute a complex sequence of steps, e.g., a series of button presses, just to set up the alarm clock. For example, to set the time to “11:49 AM” and “October 2” in the prior art alarm clock, one typically presses a “Set Clock” button to enter a clock time setting mode, presses a “+” or “−” button to select AM or PM, presses a “SET CLOCK” button to confirm a setting and to change the clock hour, repeatedly presses or holds the “+” or “−” button until the hour digit “11” appears, presses the “Set Clock” button again to confirm the setting and to change the clock minute, repeats the sequence to finish setting the clock minute to “49,” and again repeats a button-pressing sequence to set the calendar to “October 2.”

### SUMMARY OF THE INVENTION

In one aspect, an alarm clock system employs voice synthesis technology to control alarm clock functions without physical manipulation of the system. One or more processors control clocking and alarm functions within a modular unit. The processors include a speech recognition processor to digitize and process audible commands. A microphone senses the audible commands for input to the processors.

In one aspect, the microphone is remote from the modular unit, and connects to the unit by an electronic wire. The microphone may then be placed near to a person to facilitate audible control of the clock. By way of example, the microphone may be placed adjacent the person's head on a bed.

In another aspect, the microphone is wirelessly coupled to the modular unit, to provide greater options for placement of the microphone relative to the modular unit. For example, the modular unit may be placed on the wall, and the microphone may be placed on a night-stand adjacent a bed.

In another aspect, the system is configured to sense voice commands within approximately thirty inches of the microphone. This thirty inches advantageously permits voice-commanded timing and clocking control, while filtering out-of-range sound.

In other aspects, the alarm clock system includes a wireless transmitter to control other electronic devices—e.g., a radio, television, a compact disc player, a DVD player, a satellite cable box, a stereo system, a cooking thermometer device, a hair treatment device, a light switch or socket, an air-conditioner, a wireless A/C timer socket, a coffee machine, and/or a VCR—based on the alarm or clocking functions of the alarm clock system. The electronic device has a corresponding wireless receiver to capture and interpret data from the wireless transmitter.

In still another aspect, the alarm clock system includes an AM and/or FM radio that responds to timing and/or alarm functions of the alarm clock system. For example, when commanded by voice commands, the alarm clock system turns on the radio at a specified time.

In one aspect, the alarm clock system includes a snooze alarm clock feature, whereby the alarm clock system responds to audible user commands to facilitate snooze features. By way of example, an audible command such as “Snooze” may be used to terminate an alarm for a delay such as ten minutes.

In another aspect, the alarm clock system is set up by initial programming. After the initial programming, the alarm clock system responds to voice commands as set forth in the initial programming. The initial programming may, for example, include a learning sequence in which the speech recognition processor associates voice commands to alarm functions. By way of example, with appropriate learning sequences, the alarm clock system may be activated for alarm functions by an audible alarm command such as “Turn alarm on.” Another audible voice command such as “Turn alarm off” may be used to turn the alarm functions off. Similarly, in other aspects, timing functions (e.g., time and date) may be set within the alarm clock system by voice commands such as “Set time” and “Set date.” Once these timing commands are made, the user speaks the correct time or date, respectively, to set timing for the alarm clock system. A real time clock may be used to track time within the alarm clock system, for example.

In yet another aspect, the alarm clock system is set to respond to voice commands by an initializing audible voice command such as “Voice command.” After the initializing audible voice command is made, the alarm clock system responds to audible commands such as “Turn alarm off.” In another aspect, the alarm clock system is turned off by a command such as “Manual setting,” whereinafter the alarm clock system will not respond to voice commands other than the initializing audible voice command.

In one aspect, the alarm clock system audibly speaks instructions to a user, for example to facilitate the initial programming. The alarm clock system may further visually indicate “icon” or “digit” so as to facilitate the initial programming.

The alarm clock system, in other aspects, provides procedures for direct setting of voice command data. These procedures avoid complex “step by step” programming involving pressing a complex series of button sequences. In one aspect, a voice command to set the clock of the alarm clock system is initiated by saying “Set Clock.” To set the alarm clock system to 11:49 AM, November 12, for example, voice data is thereafter entered by speaking “AM,” “11,” “49,” “2,” “11,” “12.” These step sequences greatly reduce the complexity of prior art alarm clock setting procedures.

In another aspect, the alarm clock system includes a snooze button. The alarm clock system may further include, with or without this snooze button, voice control capability to terminate an alarm until a later time by saying “Sleep longer”—thereby providing like functionality of a snooze button but without requiring hand movement to hit a snooze button. This aspect thus beneficially assists sleeping persons in waking up each day, to further enjoy pleasant sleep during a snooze period with least interruption to her overall sleep, and without using hands and fingers.

In other aspects, the clock alarm system provides for learning sequences. In a first aspect, a default programming sequence is used, e.g., 0, 1, 2, 3, 4, 5, . . . 10, 11 . . . 20, 30, 40, 50, AM, PM, VOICE SETTING, and VOICE COMMAND. A button (e.g., a button labeled with “Learn”) on the alarm clock system is pressed and a display with the alarm clock system shows “0” and “SPEAK ZERO,” to guide the user to say “Zero” so that the alarm clock system will recognize and appropriately log this user's voice for “0.” Further display of words and/or numbers of the default programming sequence, and associated prompting to the user to speak these words and/or numbers, provides for further recognition and logging of the words and/or numbers in the alarm clock system, such as listed above. These basic word and number inputs of the default programming sequence provide the processor with background electronic digital data to facilitate further commands in the Voice Setting mode, e.g., to set date and time information to the alarm clock system.

In one aspect, the default programming has a default interval (e.g., eight seconds) between each of the words or numbers. This interval helps filter other noises out of the alarm clock system. In one example, the user at an interval makes a voice command such as “Stop The Alarm” or “Sleep Longer.”

This interval setting enables easy operation within an actual living environment, allowing the processor to identify a voice signal and subsequently execute the appropriate related command while filtering out background noise, including the sound of the alarm itself.

In still another aspect, the alarm clock system is programmable so that a user may choose the words associated with a particular function. A user may thus utilize his preferred voice and words to activate the particular function. By way of example, the alarm clock system may be activated for alarm by saying “Alarm on” by programming the alarm clock system, in a learning mode, to activate the alarm function by speaking “Alarm on.”

In one aspect, the alarm clock system “speaks” audible tones to assist in programming during the learning mode. For example, in one aspect the “Learn” button is pressed and another button (e.g., a button labeled “Alarm On/Off”) of the alarm clock system is pressed to activate alarm ON and alarm OFF functions. A “bell” icon on a display of the alarm clock system flashes and the alarm clock system says “Speak.” The user, in turn, says his desired words, such as “Turn alarm on” or “Wake me up”, to set the desired function. The user may use any words with sufficient length and distinctive tone rhythms. In one aspect, the alarm clock system displays and/or speaks “Fail, please try again” when the user's words were not appropriately interpreted and logged.

Accordingly, another feature presented herein is a visual-audible display system that facilitates automated voice-controlled input of learning features. Such a display system has applications in devices other than an alarm clock system. For example, the display system may be integrated with an AC power socket to automate power on or power off functionality of electronic devices coupled to the AC power socket.

There may be several advantages to certain of the alarm clock systems described herein. By way of example, a user may set and/or disable alarm functions by voice commands and without physical manipulation of the alarm clock system. Accordingly, control of the alarm clock system may be maintained in darkness. In another example, a user of the alarm clock system can say “Sleep longer” to achieve a functionality that is normally obtained by pressing a “Snooze” button; this user may thus further enjoy a pleasant sleep with the least interruption by speaking a simple voice command.

Further advantages of the alarm clock system may include assisting the blind, disabled, elderly and children by voice-assisted setting and controlling of alarm clock functions.

### BRIEF DESCRIPTION OF THE DRAWINGS

FIG. 1 shows a schematic block diagram of one alarm clock system;

FIG. 2 shows a schematic block diagram of another alarm clock system;

FIG. 3 shows a schematic block diagram of another alarm clock system;

FIG. 4 shows one modular housing unit (in 3 perspective views) suitable for use with the systems of FIG. 1-FIG. 3;

FIG. 5 shows one flowchart illustrating various methods suitable for implementation with an alarm clock system such as shown in FIG. 1-FIG. 4; and

FIG. 6 shows an AC power outlet device.

### DETAILED DESCRIPTION OF THE DRAWINGS

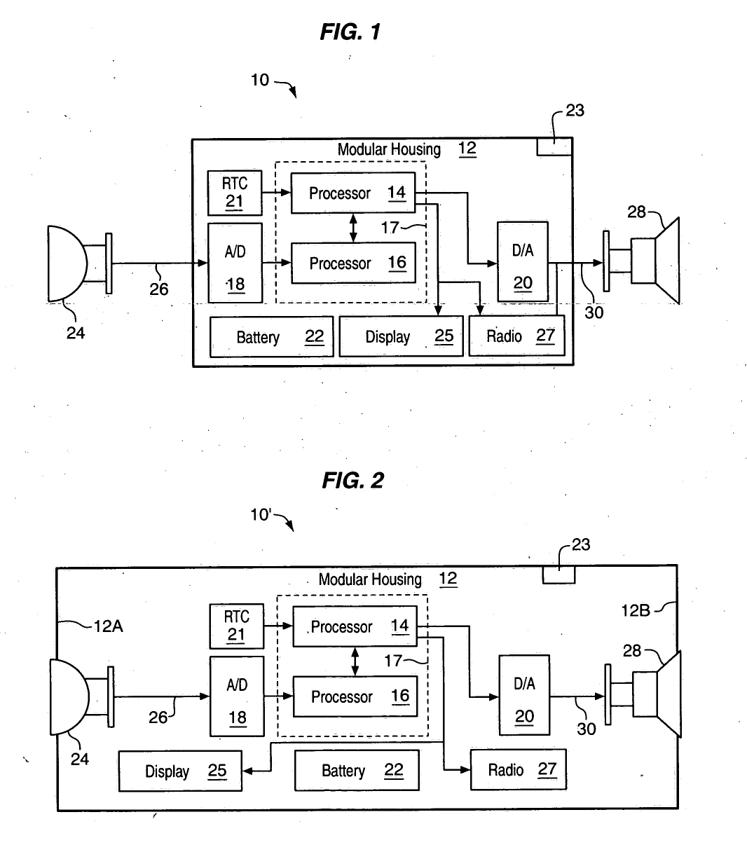

FIG. 1 shows one alarm clock system 10. System 10 includes a modular housing 12 to encase and protect system processors 14, 16, analog-to-digital (A/D) converter 18, digital-to-analog (D/A) converter 20, real time clock (RTC) 21, and battery 22. System 10 may further include one or more buttons 23 as a manual user interface to system 10, and/or a display 25 to show time and date information (e.g., an actual time from real time clock 21 or an alarm set time). A microphone 24 connects with housing 12 via a communications link 26; by way of example link 26 is a wire that extends some distance (e.g., fifteen centimeters to ten meters) from housing 12. A speaker 28 also connects with housing 12 via a communications link 30; by way of example, link 30 is a wire that extends some distance (e.g., fifteen centimeters to ten meters) from housing 12.

In operation, sound generated external to housing 12 is captured by microphone 24 and converted to digital information through A/D converter 18. A speech recognition processor 16 assesses digital data representative of the sound to determine whether the sound includes voice command data. If voice command data is detected, a signal is communicated to processor 14, which performs certain functions dependent upon the voice command data. The voice command data may include instructions to set an alarm for a time provided by real time clock 21. In one example, these voice instructions may be “Set alarm for 7 AM”—processor 14 then commands an audible alarm through speaker 28 at 7 AM.

In one embodiment, system 10 starts assessing voice command data with an initializing audible voice command spoken as “Voice command.” Upon detecting this voice command data, system 10 thereafter listens and processes sounds for other voice command data. Once in this mode, for example, a user may set an alarm within system 10 by using a command such as “Set alarm”. In another example, once an alarm goes off through speaker 28, a user may initiate a snooze command by saying, for example, “Snooze.”

Voice command data is preferably preprogrammed to system 10 by initial programming. The voice command data may for example include the following voice programming during learning sequencing: “Turn alarm off” to turn an alarm off; “Voice command” to activate system 10 to voice commands; “Set alarm” to set the alarm to a specified time; “Manual setting” so to disable some or all voice commands.

Those skilled in the art should appreciate that processors 14, 16 may be formed as a single processing unit (e.g., an application specific integrated circuit, or “ASIC”), as a matter of design choice, as indicated by processing unit 17. Voice command data may be stored as digital data within memory (not shown) of processors 14, 16 or processing unit 17. Those skilled in the art should further appreciate that processing unit 17 may further incorporate one or more additional processors as a matter of design choice. In another embodiment, A/D and D/A converters 18, 20 are also incorporated within processors 14, 16 and/or unit 17.

Those skilled in the art should further appreciate that link 26 may be formed as a wireless link 26 between housing 12 and microphone 24; in this embodiment microphone 24 includes a wireless transmitter and housing 12 includes a corresponding wireless receiver. Microphone 24 may include a separate battery to power microphone 24.

Those skilled in the art should further appreciate that link 30 may be formed as a wireless link 30 between housing 12 and speaker 28; in this embodiment, housing 12 includes a wireless transmitter and speaker 28 includes a corresponding wireless receiver; and speaker 28 typically includes a separate battery to power speaker 28.

As shown by alarm clock system 10′ of FIG. 2, those skilled in the art should appreciate that microphone 24 and link 26 may be substantially internal to housing 12, as a matter of design choice. In this embodiment, an aperture formed in a wall 12A of housing 12 may be used to transmit externally-generated sound through wall 12A and to microphone 24. Those skilled in the art should also appreciate that speaker 28 and link 30 may be substantially internal to housing 12, as a matter of design choice. In this embodiment, an aperture formed in a wall 12B of housing 12 maybe used to transmit sound from speaker 28 through wall 12B. In FIG. 2, elements that are numbered similarly to elements of FIG. 1 indicate elements with like functions.

Optionally, systems 10, 10′ may include a radio 27 (e.g., an AM and/or FM radio) that generates radio through speaker 28 when system 10, 10′ initiate an alarm, so that a user may, for example, awake to music or news. Accordingly, radio 27 may be set to play by voice commands as disclosed herein.

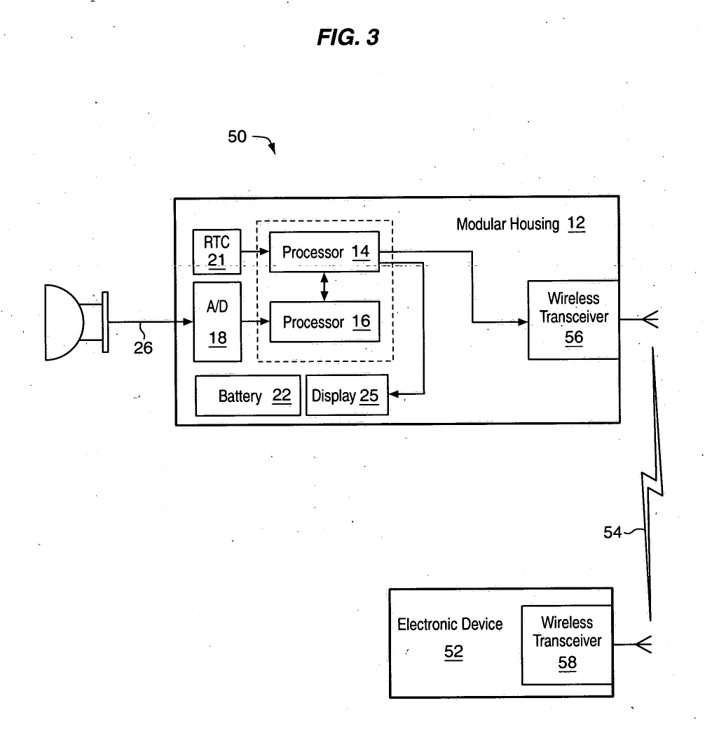

FIG. 3 shows one alarm clock system 50 suitable for alarming an electronic device 52. In FIG. 3, elements that are numbered similarly to elements of FIG. 1 indicate elements with like functions. Unlike system 10 of FIG. 1, an alarm is wirelessly communicated (as wireless data 54) from housing 12 to device 52 through a transceiver pair 56, 58 (or transmitter-receiver pair 56, 58, respectively). Electronic device 52 may for example be a radio, television, compact disc player, DVD player, satellite cable box, cooking thermometer device, hair treatment device, a light switch, an air conditioner, an A/C socket, a coffee machine, or a VCR. Accordingly, a user may set alarm system 50 to set off an alarm at a desired time (of real time clock 21) and, thereby, activate or deactivate device 52 (e.g., to start coffee).

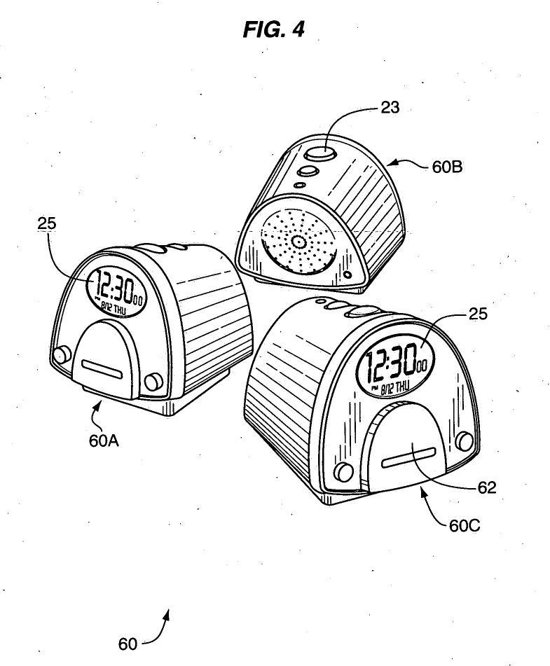

FIG. 4 shows one modular housing unit 60 suitable for use as housing 12; unit 60 is set forth in three different views: front perspective view 60A, back perspective view 60B, and third perspective view 60C. Unit 60 may include an illuminating light 62 to provide soft lighting to areas external unit 60.

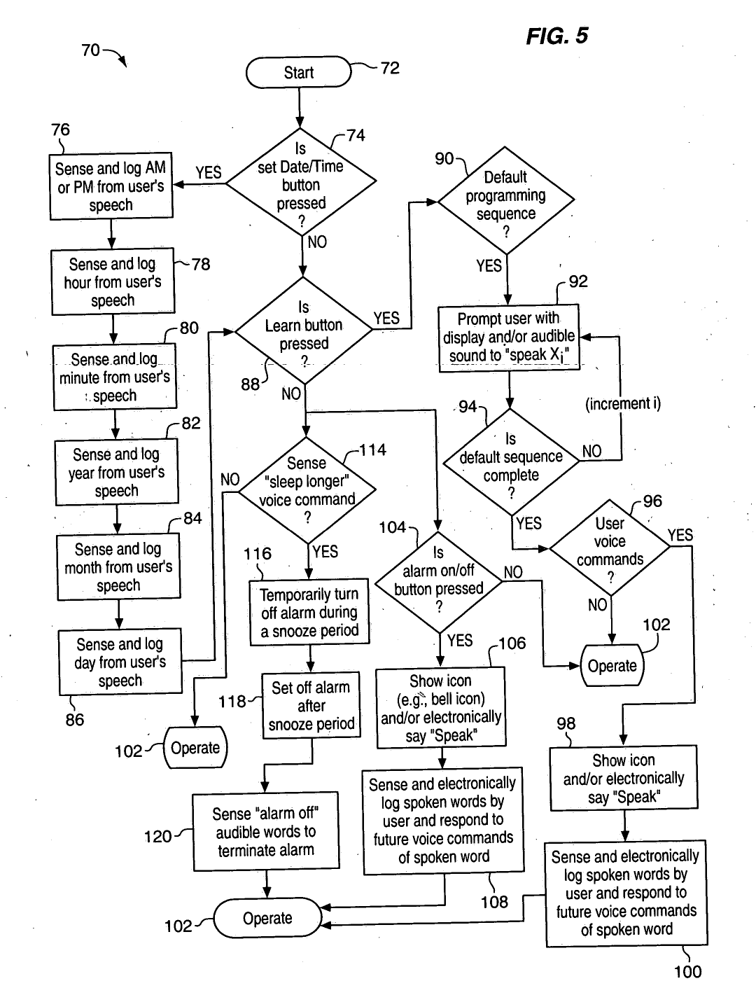

FIG. 5 shows one flowchart 70 illustrating several method steps, any or all of which maybe implemented with the alarm clock systems of FIG. 1-FIG. 4. By way of example, these method steps may be implemented as software instructions and/or logical elements within electronic architecture (e.g., within processors) of such systems. After start 72, the alarm clock system determines whether the set date/time button is pressed, in step 74. If the set date/time button is pressed, the alarm clock system sequentially senses and logs the user's voice response to log AM or PM (step 76), the hour of the day (step 78), the minute of the day (80), the year (step 82), the month (step 84), and the day (step 86). Steps 76-86 may be in any order. In step 88, the alarm clock system determines whether the learn button is pressed. If yes, and if the alarm clock system is to enter a default programming sequence (step 90), step 92 commences to prompt the user (through the display or through synthetic audible speech from the alarm clock system) to speak “Xᵢ”. Xᵢ is used symbolically to indicate any number or word in a series i (i=an integer number), such as a default sequence of 0, 1, 2, 3, 4, 5, . . . 10, 11 . . . 20, 30, 40, 50, AM, PM, VOICE SETTING, and VOICE COMMAND. The default sequence may include a delay interval between each word Xᵢ so as to filter out unwanted sound and to assist in word interpretation. When the default sequence is complete (step 94), and if other user commands are to be recorded (step 96), the alarm clock system may prompt the user through the display and/or through electronic audible speech to “speak” the desired words associated with the user's intended function (e.g., to start or stop the alarm), step 98. The words of the user are sensed and logged (step 100) for future reference. Thereafter, until over-recorded, the alarm clock system operates to perform the user's intended function during normal operation 102. Those skilled in the art should appreciate that steps 92-94 may be avoided or skipped to process instead steps 96-102. Step 102 may include recycling through steps of flowchart 70, such as from start 72.

In one mode of operation, the alarm clock system senses when an alarm on/off button is pressed in step 104. If yes, an icon may be shown on a display of the alarm clock system and/or the alarm clock system may electronically say “speak” in step 106, to prompt the user for the voice command. The words from the user are sensed and logged in step 108, so that the alarm clock system will operate when commanded. In one example of operation 102, the alarm clock system monitors an audible command for a snooze function, in step 114. If the alarm clock system senses a voice command to snooze (e.g., via a “sleep longer” command programmed via steps 96-100), the alarm is temporarily terminated, in step 116, during the snooze period. At the end of the snooze period, the alarm again commences in step 118. The alarm clock system may sense another voice command (e.g., an “alarm off” command programmed via steps 104-108) to turn off (in step 120) the alarm and continue operation 102.

Those skilled in the art should appreciate that various steps 74-120 may be in different order. For example, after start 72, step 88 may commence prior to step 74 as a matter of design choice. Moreover, steps may be added or deleted from flowchart 70 without departing from the scope hereof. For example, steps 74-86 or steps 104-108 may be deleted from certain systems.

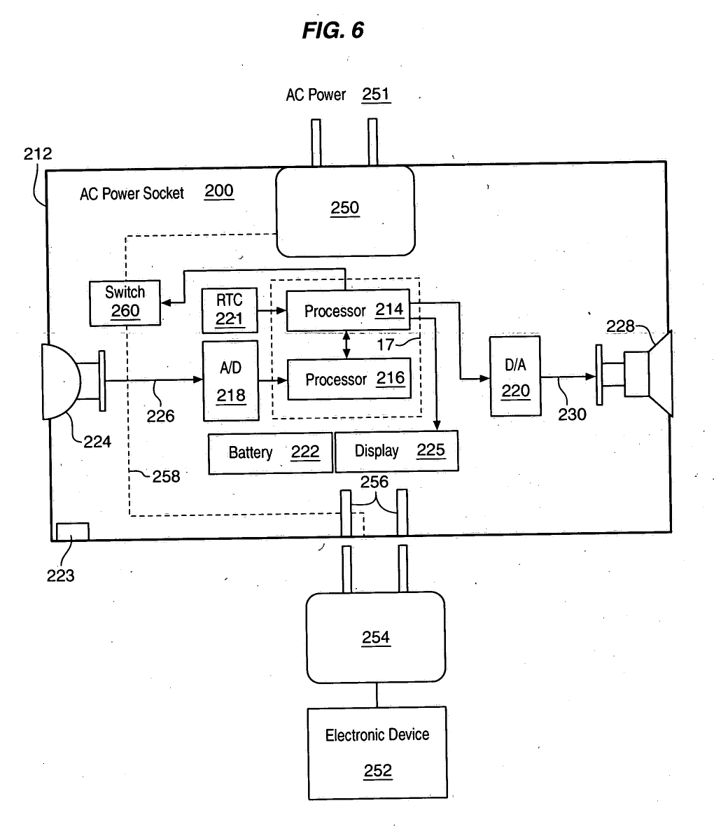

FIG. 6 shows one A/C power socket 200. Socket 200 includes a modular housing 212 to encase and protect system processors 214, 216, analog-to-digital (A/D) converter 218, digital-to-analog (D/A) converter 220, real time clock 221, and optional battery 222. Socket 200 may further include one or more buttons 223 as a manual user interface to socket 200, and/or a display 225 to show time and date information (e.g., an actual time from real time clock 221 or an alarm set time). A microphone 224 connects with A/D converter 218 as shown via electronic link 226. Optionally, a speaker 228 also connects to a D/A converter 220 as shown via an electronic link 230.

Socket 200 includes a plug 250 that couples to A/C power 251; optionally this power may power socket 200 without need of battery 222. An external electronic device 252 may then plug into socket 200, via its own plug 254 coupling into receptacles 256 of socket 200, to couple device 252 to that same A/C power 251 through power link 258. Socket 200 controls power through link 258, on or off, via a power switch 260. Socket 200 operates to turn device 252 on or off in conjunction with voice-commanded alarming.

More particularly, sound generated external to housing 212 is captured by microphone 224 and converted to digital information through A/D converter 220. A speech recognition processor 216 assesses digital data representative of the sound to determine whether the sound includes voice command data. If voice command data is detected, a signal is communicated to processor 214, which performs certain functions (e.g., disconnecting or connecting power through link 258, via switch 260) based upon the voice command data. The voice command data may include instructions to set an alarm for a time provided by real time clock 221. In one example, these voice instructions may be “Disconnect power at 7 PM”—processor 214 then commands the disconnection of power to device 252 at 7 PM. Speaker 224 may be used in accord with the teachings herein to assist in programming socket 200.

Those skilled in the art should appreciate that processors 214, 216 may be formed as a single processing unit (e.g., an application specific integrated circuit, or “ASIC”), as a matter of design choice, as indicated by processing unit 17. Voice command data may be stored as digital data within internal memory (not shown) of processors 214, 216 or processing unit 17. Those skilled in the art should further appreciate that processing unit 17 may further incorporate one or more additional processors as a matter of design choice. In one embodiment, A/D and D/A converters 218, 220 are also incorporated within processors 214, 216 and/or unit 17.

Since certain changes may be made in the above methods and systems without departing from the scope of hereof, it is intended that all matter contained in the above description or shown in the accompanying drawing be interpreted as illustrative and not in a limiting sense. It is also to be understood that the following claims are to cover all generic and specific features of the invention described herein, and all statements of the scope of the invention which, as a matter of language, might be said to fall there between.

What is claimed is:

1. An alarm clock system, comprising:
a microphone for sensing sound; and
at least one processor for processing the sound to determine voice commands, and for generating an alarm signal based on the voice commands.

2. A system of claim 1, further comprising a real time clock for tracking time for the alarm clock system, the alarm signal being generated at a time of the real time clock.

3. A system of claim 1, further comprising a speaker responsive to the alarm signal to generate audible sound.

4. A system of claim 3, further comprising a radio for generating at least one of music and news as the audible sound.

5. A system of claim 1, further comprising a battery for powering the system.

6. A system of claim 1, further comprising a modular housing for encasing and protecting the processor, and a communications link between the housing and the microphone.

7. A system of claim 6, the communications link comprising an electronic wire for positioning the microphone remotely from the housing.

8. A system of claim 6, the communications link comprising a wireless relay for positioning the microphone remotely from the housing.

9. A system of claim 1, the processor comprising a speech synthesis processor to recognize voice data.

10. A system of claim 9, the processor being configurable to initial programming, to identify audible words as voice commands after the initial programming.

11. A system of claim 10, further comprising memory for storing digital data representative of the voice commands.

12. A system of claim 1, further comprising a wireless transmitter for communicating the alarm to a remote electronic device.

13. A system of claim 12, further comprising an electronic device having a wireless receiver and selected from the group of radio, television, compact disc player, DVD player, satellite cable box, cooking thermometer device, hair treatment device, a light switch, an air conditioner, an A/C socket, a coffee machine, or a VCR.

14. A system of claim 1, further comprising a display for showing time and date information.

15. A system of claim 1, further comprising an A/D converter for digitizing the sound for the processor.

16. A method for generating an alarm, comprising the steps of:
automatically sensing sound through a microphone;
electronically processing the sound to determine one or more voice commands; and
generating an alarm at a time set by the voice commands.

17. A method of claim 16, the step of generating an alarm comprising generating an audible noise through a speaker.

18. A method of claim 16, the step of generating an alarm comprising generating music through a speaker.

19. A method of claim 16, the step of sensing sound comprising sensing sound at a location remote from the step of processing the sound.

20. A method of claim 16, the step of electronically processing comprising processing the sound and comparing the processed sound to stored data from a learning sequence.

21. A method of claim 16, the step of generating an alarm comprising the step of generating a wireless signal to a remote electronic device.

22. A method of claim 21, further comprising the step of activating or deactivating the electronic device upon receipt of the wireless signal.

23. A method of claim 16, further comprising the step of initiating the step of processing the sound by detecting an initializing audible voice command.

24. A method of claim 23, the initializing audible voice command comprising “Voice command.”

25. A method of claim 23, further comprising the step of stopping the step of processing the sound by detecting a terminating audible voice command.

26. A method of claim 25, the terminating audible voice command comprising “Manual setting.”

27. An A/C power socket, comprising:
a plug for coupling the A/C power socket to A/C power;
a receptacle for accepting a plug from an external electronic device;
a microphone for sensing sound;
at least one processor for processing the sound to determine voice commands, and for generating a signal based on the voice commands; and
means for disconnecting and alternatively connecting the A/C power to the external device in response to the signal.

28. An A/C power socket of claim 27, the means for disconnecting and alternatively connecting comprising a power switch.

29. A process for setting date and time of an alarm clock system through voice-control, comprising the steps of:
sensing engagement of a button of the alarm clock system, the button being designated, at least in part, for setting date and time;
if the button is engaged, automatically and sequentially sensing and storing audible sounds emanating from the user, the audible sounds comprising a plurality of (1) AM or PM, (2) hour of the day, (3) minute of the day, (4) year, (5) month, and (6) day; and
automatically setting the date and time within the alarm clock system based on the audible sounds.

30. A process of claim 29, the step of automatically and sequentially sensing and storing comprising providing a delay interval between successive audible sounds.

31. A process of claim 30, the delay interval being at least four seconds.

32. A process of claim 31, the delay interval being eight seconds.

33. A process for setting an alarm for an alarm clock system through voice-control, comprising the steps of:
sensing engagement of a button of the alarm clock system, the button being designated, at least in part, for setting an alarm;
once the button is engaged, sensing and storing audible sounds emanating from the user; and
automating alarm functions of the alarm clock system based on future use of the audible sounds.

34. A process of default programming in an alarm clock system through voice-control, comprising the steps of:
entering a learning mode of the alarm clock system;
prompting the user to speak one word of a sequence of words;
capturing and storing audible sounds corresponding to the user's speech of the one word;
if additional words exist in the sequence of words, repeating steps (2) and (3) to sense and store audible sounds of every other word in the sequence of words;
exiting the learning mode; and
responding to the audible sounds corresponding to one or more of the sequence of words to set time, date and to initiate automatic action within and by the alarm clock system.

35. A process of claim 34, the sequence of words comprising one or more of the following: 0, 1, 2, 3, 4, 5, . . . 10, 11 . . . 20, 30, 40, 50, AM, PM, VOICE SETTING, and VOICE COMMAND.

36. A process of claim 31, the step of prompting comprising one or both of (a) displaying information on a display of the alarm clock system and (b) electronically synthesizing human speech encouraging the user to speak.
